(19) United States
(12) Patent Application Publication
(10) Pub. No.: US 2016/0163486 A1
(43) Pub. Date: Jun. 9, 2016

(54) SWITCH STRUCTURE

(71) Applicant: proeasy network solutions co., LTD., Hsinchu County (TW)

(72) Inventor: Hsing-Hung Lu, Hsinchu County (TW)

(21) Appl. No.: 14/623,512

(22) Filed: Feb. 17, 2015

(30) Foreign Application Priority Data
Dec. 8, 2014 (TW) 103142595

(51) Int. Cl. H01H 50/20; H01H 50/64; H01H 50/74

(52) U.S. Cl. CPC H01H 50/20; H01H 50/74; H01H 50/641

(57) ABSTRACT

A switch structure including a first electrode, a second electrode, a first moving member disposed next to the first electrode along a first axis and having a first tenon unit, and a second moving member disposed at an end of the first moving member and facing the first electrode is provided. The second moving member movably disposed next to the first moving member has a second tenon unit. The first axis is orthogonal to the second axis. When the first moving member moves to a first position and the second moving member moves to a second position, the first and the second tenon units are interfered with each other, and the first electrode is electrically connected to the second electrode. When the second moving member moves to a third position, the first moving member moves along the first axis and passes by the second moving member.

### CROSS-REFERENCE TO RELATED APPLICATION

This application claims the priority benefit of Taiwan application serial no. 103142595, filed on Dec. 8, 2014. The entirety of the above-mentioned patent application is hereby incorporated by reference herein and made a part of this specification.

### BACKGROUND

1. Technical Field

The invention relates to a switch structure, and particularly relates to a switch structure of a power line device.

2. Related Art

A general local area network (LAN) in home can be a wired Ethernet LAN, a wired IEEE 802.11x LAN, or a home plug constructed by using power lines laid in home. The home plug is a communication network constructed by using the power lines already existing in home based on a power line communication (PLC) technique, and a user is only required to connect the home plug to an alternating current (AC) power outlet installed in home, or the home plug can be preinstalled in a house power line system during construction or decoration of the house, and then the user can use the power line to access the Internet without additionally installing a network line, so as to achieve a purpose of LAN communication and network resource sharing.

However, an existing switch structure used for activating the home plug is limited to a following situation: the power is first supplied to the switch to activate an electromagnetic valve therein, and the electromagnetic valve pushes electrodes to contact each other or separate from each other, and once supply of the power is stopped, the electromagnetic valve is accordingly turned off, so that the power has to be continuously provided in order to keep activating the home plug, and energy saving cannot be effectively achieved.

### SUMMARY

The invention is directed to a switch structure, in which two moving members are used to achieve a turning on/off effect of the switch structure in a power saving mode.

The invention provides a switch structure including a first electrode, a first moving member, a second electrode and a second moving member. The first moving member is movably disposed next to the first electrode along a first axis. The first moving member has a first tenon unit. The second electrode is disposed at one end of the first moving member and faces the first electrode. The second moving member is movably disposed next to the first moving member along a second axis. The second moving member has a second tenon unit. The first axis is orthogonal to the second axis. When the first moving member moves to a first position and the second moving member moves to a second position, the first tenon unit and the second tenon unit are interfered with each other, and the first electrode is electrically connected to the second electrode. When the second moving member moves to a third position, the first moving member moves along the first axis and passes by the second moving member.

In an embodiment of the invention, the switch structure includes a first electromagnetic valve unit and a second electromagnetic valve unit. The first electromagnetic valve unit has a first coil, a first power supply and the first moving member. The first moving member is sleeved by the first coil, and the first power supply is electrically connected to the first coil. The second electromagnetic valve unit has a second coil, a second power supply and the second moving member. The second moving member is sleeved by the second coil, and the second power supply is electrically connected to the second coil.

In an embodiment of the invention, the first tenon unit includes a first block and a first groove arranged along the first axis. The second tenon unit includes a second block and a second groove arranged along the second axis. When the first moving member moves to the first position, and the second moving member moves to the second position, the second block moves to the first groove to interfere with the first block, such that the second moving member stops the first moving member to move along the first axis. When the second moving member moves to the third position, the first moving member moves along the first axis and passes by the second groove.

In an embodiment of the invention, the switch structure further includes a substrate and an elastic member. The substrate is located at one side of the first moving member along the first axis. The elastic member is connected between the substrate and another end of the first moving member relative to the second electrode. The elastic member keeps driving the first moving member to depart from the first position.

In an embodiment of the invention, the switch structure further includes a substrate and an elastic member. The substrate is located at one side of the first moving member along the first axis. The elastic member is connected between the substrate and another end of the first moving member relative to the second electrode. The elastic member keeps driving the first moving member to move to the first position.

In an embodiment of the invention, the switch structure further includes a third electrode and a fourth electrode. The third electrode is disposed relative to the first electrode along the first axis. The fourth electrode is disposed on the first moving member at another end relative to the second electrode. The fourth electrode faces the third electrode. When the first moving member moves to the first position, and the second moving member moves to the second position, the third electrode is away from the fourth electrode. When the first moving member moves to a fourth position, the third electrode is electrically connected to the fourth electrode, and the first electrode is away from the second electrode.

In an embodiment of the invention, the first tenon unit includes a first block, a first groove and a third groove arranged along the first axis. The second tenon unit includes a second block and a second groove arranged along the second axis. When the first moving member moves to the first position, and the second moving member moves to the second position, the second block moves to the first groove to interfere with the first block, or when the first moving member moves to a fourth position, and the second moving member moves to the second position, the second block moves to the third groove to interfere with the first block, such that the second moving member stops the first moving member to move along the first axis.

In an embodiment of the invention, the first block is located between the first groove and the third groove.

According to the above descriptions, based on orthogonal configuration of the two moving members of the switch structure and the tenon units disposed thereon, the electrode disposed on the first moving member is adapted to be electrically connected to or separate from the corresponding electrode along with movement of the first moving member, and meanwhile the second moving member is buckled to the first moving member located at the above position by using the tenon unit, such that the first moving member is fixed to an electrode connection position. Even if the power is not supplied, the electrodes still maintain an electrical connection relationship due to fixing of the first moving member, i.e., the switch structure is still in a turn-on state. In this way, the switch structure is unnecessary to keep providing power to maintain the first moving member to the electrode connection position, so as to achieve a power saving effect.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a partial schematic diagram of a power line device according to an embodiment of the invention.

FIG. 2 is an enlarged view of a switch structure in the power line device of FIG. 1.

FIG. 3 and FIG. 4 are schematic diagrams of moving members of FIG. 2 in different states.

FIG. 5 to FIG. 7 are schematic diagrams of a switch structure according to another embodiment of the invention

### DETAILED DESCRIPTION OF DISCLOSED EMBODIMENTS

Since power lines are widely used and a coverage rate thereof is the most extensive, if the existing power lines can be used to extend network to each corner of user's house (i.e., to use a power line outlet to conveniently access the network), a huge cost for re-laying network lines is saved, and a problem of cross-floor or a wall shielding problem due to usage of wireless communication is also avoided. Therefore, technical standards for power line communication (PLC), for example, HomePlug 1.0, etc. have been developed and applied to related electronic devices.

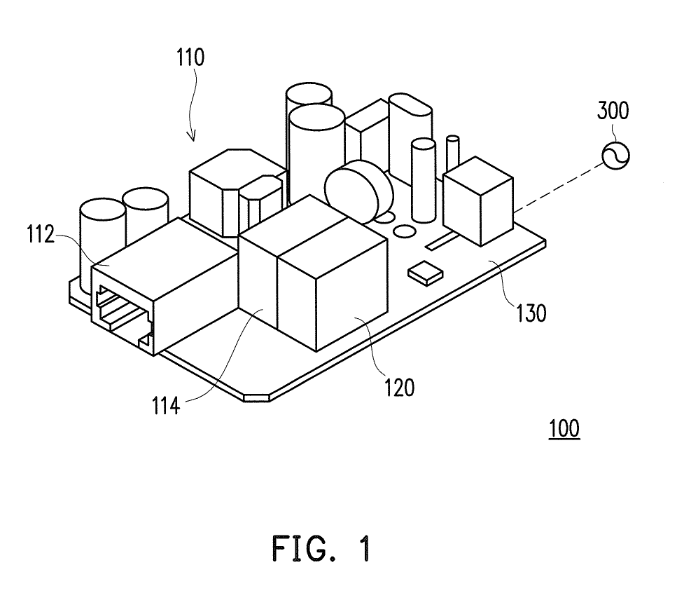

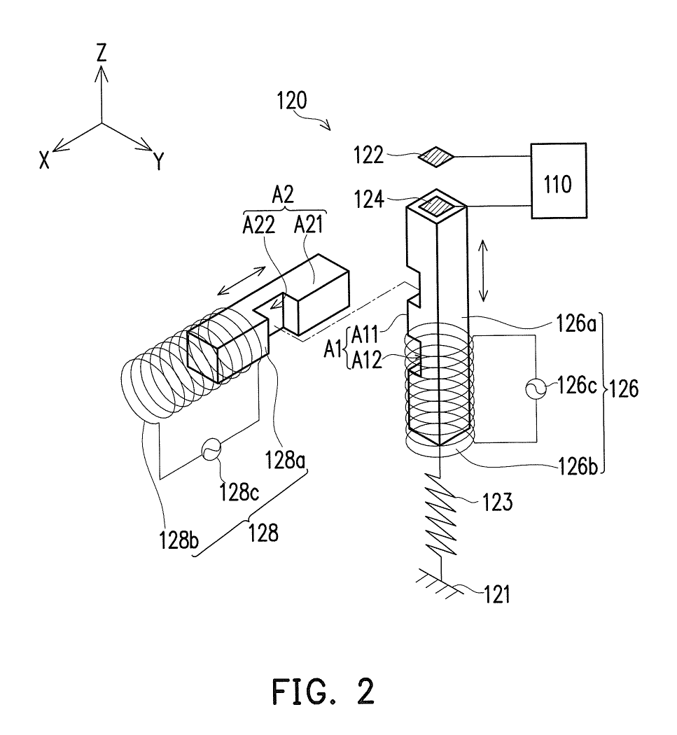

FIG. 1 is a partial schematic diagram of a power line device according to an embodiment of the invention. FIG. 2 is an enlarged view of a switch structure in the power line device of FIG. 1. FIG. 1 only illustrates relative positions of related elements, and detailed structure thereof is shown in FIG. 2. In the present embodiment, the power line device 100 includes a communication unit 110, a switch structure 120 and a circuit substrate 130, where the communication unit 110 is a related element in the power line device 100 that provides a network communication function, and includes a RJ45-type connector 112 and a related electronic element 114 connected thereto, where content thereof is known based on the existing power line device, so that detail thereof is not repeated, and a type of the communication unit 110 is not limited by the invention. Moreover, the communication unit 110 and the switch structure 120 are all disposed on the circuit substrate 130 and are electrically connected to each other, and in the present embodiment, the communication unit 110 is adapted to be turned on or turned off by the switch structure 120.

In the present embodiment, the power line device 100 can be an electronic component directly installed to a home plug, i.e., the power line device 100 can be installed during construction or decoration of a building, i.e., the circuit substrate 130 is preinstalled to a power line 300, and is regarded as one of a plurality of contacts of the whole power line in the building. On the other hand, in an embodiment that is not illustrated, the power line device can also be an external electronic component, which can be connected to a power outlet in house through a power terminal, so as achieve the same effect. Therefore, a usage pattern of the power line device is not limited by the invention.

Referring to FIG. 2, the Cartesian coordinate system is provided to facilitate describing the related components. In the present embodiment, the switch structure 120 includes a first electrode 122, a second electrode 124, a first electromagnetic valve unit 126 and a second electromagnetic valve unit 128. The first electrode 122 and the second electrode 124 are disposed in the power line device 100 along a Z-axis. The first electromagnetic valve unit 126 includes a first moving member 126a, a first coil 126b and a first power supply 126c, where the first moving member 126a is sleeved by the first coil 126b, and the first power supply 126c is electrically connected to the first coil 126b. The second electromagnetic valve unit 128 includes a second moving member 128a, a second coil 128b and a second power supply 128c, where the second moving member 128a is sleeved by the second coil 128b, and the second power supply 128c is electrically connected to the second coil 128b. The second electrode 124 is disposed at one end of the first moving member 126a and faces the first electrode 122. Here, the first power supply 126c and the second power supply 128c are respectively formed by shunting the power line 300 according to existing technique.

According to the above description, the first moving member 126a and the second moving member 128a can be respectively controlled by the first coil 126b (and the first power supply 126c) and the second coil 128b (and the second power supply 128c) based on an electromagnetic effect, such that the first moving member 126a moves along the Z-axis, and the second moving member 128a moves along an X-axis. Moreover, as shown in FIG. 2, the first moving member 126a and the second moving member 128a respectively has a first tenon unit A1 and a second tenon unit A2, where the first tenon unit A1 includes a block A11 and a groove A12 arranged along the Z-axis, and the second tenon unit A2 includes a block A21 and a groove A22 arranged along the X-axis. Therefore, when the first moving member 126a and the second moving member 128a are orthogonally combined as shown in FIG. 2, a mutually interfered tenon mechanism is formed.

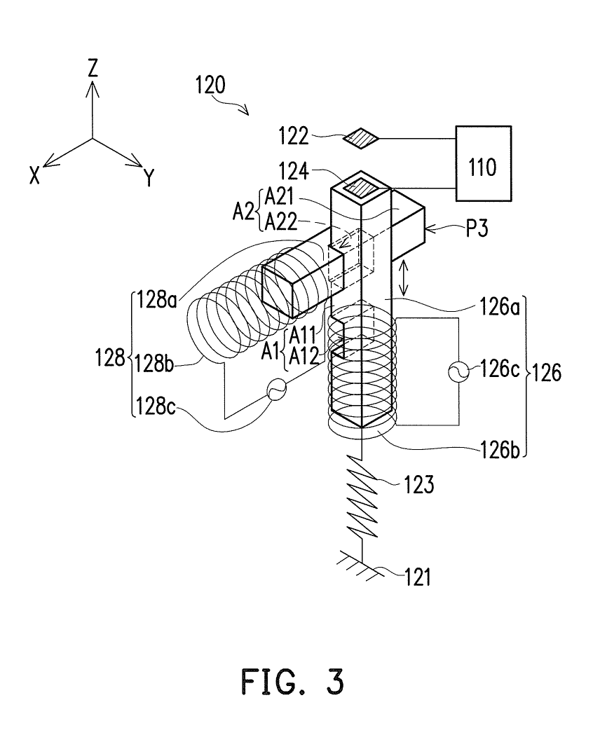

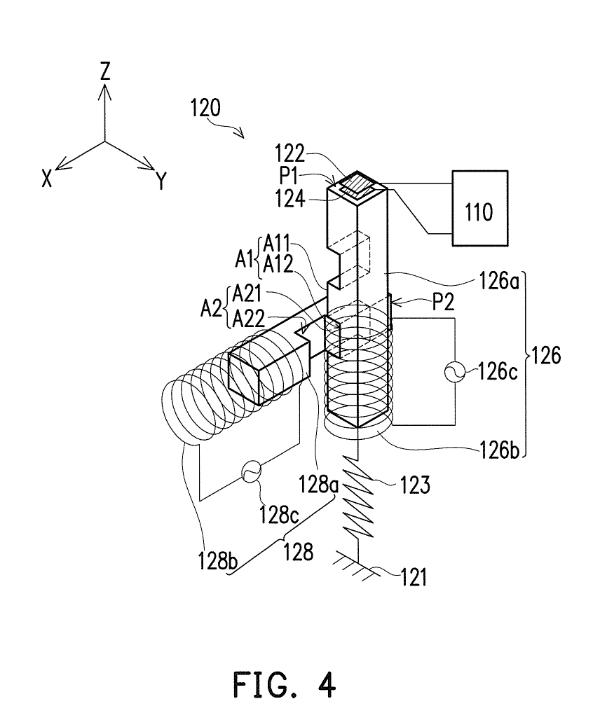

FIG. 3 and FIG. 4 are schematic diagrams of the moving members of FIG. 2 in different states. Referring to FIG. 2 to FIG. 4, in the present embodiment, the switch structure 120 further includes a substrate 121 and an elastic member 123. The substrate 121 is located at one side of the first moving member 125a away from the first electrode 122 and the second electrode 124 along the Z-axis. The elastic member 123 is connected between the substrate 121 and another end of the first moving member 126a relative to the second electrode 124, and the elastic member 123 keeps driving the first moving member 126a (and the second electrode 124 thereon) to depart from the first electrode 122.

In FIG. 3, when the second moving member 128a moves to a position P3, the first moving member 126a is substantially controlled by the first coil 126b (and the first power supply 126c) to move back and forth along the Z-axis without being influenced by the second moving member 128a. Namely, the groove A22 of the second moving member 128a is now located on a moving path of the first moving member 126a, such that the first moving member 126 can pass by the second moving member 128a via the groove A22. For example, when the first power supply 126c supplies power to the first coil 126b, a magnetic force is generated to overcome an elastic force of the elastic member 123 to drive the first moving member 126a to move towards a positive Z-axis direction, and the first electrode 122 and the second electrode 124 are electrically connected to turn on the communication unit 110, and meanwhile the elastic member 123 is deformed. When the first power 126c stops supplying the power to the first coil 126b, the elastic member 123 drives the first moving member 126a to restore its original position through an elastic restoring force, such that the first electrode 122 and the second electrode 124 are away from each other to turn off the communication unit 110.

According to the above descriptions, referring to FIG. 4, when the first moving member 126a moves to a position P1, the second electrode 124 disposed thereon contacts the first electrode 122 to achieve electrical connection, so as to turn on the communication unit 110. However, it should be noticed that if the first power supply 126c stops supplying power to the first coil 126b, the first moving member 126a cannot be maintained to the position P1 (due to that the elastic member 123 drives the first moving member 126a to restore its original position).

Therefore, in the present embodiment, by using the second moving member 128a, in the aforementioned status, the second power supply 128c and the second coil 128b can drive the second moving member 128a to move to a position P2 (from the position P3), such that the groove A22 of the second moving member 128a is moved away from the moving path of the first moving member 126a (along the Z-axis), and the block A21 is moved to the moving path of the first moving member 126a. Therefore, the block A11 of the first tenon unit A1 is interfered with the block A21 of the second tenon unit A2, and the second moving member 128a stops the first moving member 126a to move towards a negative Z-axis direction. In this way, the first moving member 126a and the second moving member 128a are structurally interfered, and now even if the first power supply 126c stops supplying power to the first coil 126b, the first moving member 126a can still be maintained to the position P1 to maintain the electrical connection relationship between the first electrode 122 and the second electrode 124, and the communication unit 110 is maintained to a turn-on state.

It should be noticed that since the first moving member 126a and the second moving member 128a are substantially orthogonal structures (with orthogonal moving paths), in case that the first moving member 126a presents a longitudinal layout and movement, the second moving member 128a presents a latitudinal layout and movement (the aforementioned orientation is based on a viewing angle shown in the figures). In this way, under a premise of none other external force, the second moving member 128a is only controlled by the second coil 128b and the second power supply 128c to move, so as to achieve an effect of blocking or releasing the first moving member 126a. According to the above descriptions, once the communication unit 110 is required to be turned off, it is only required to drive the second moving member 128a to move along the X-axis, and the groove A22 is moved back to the moving path of the first moving member 126a, such that the first moving member 126a can move towards the negative Z-axis direction to restore its original position.

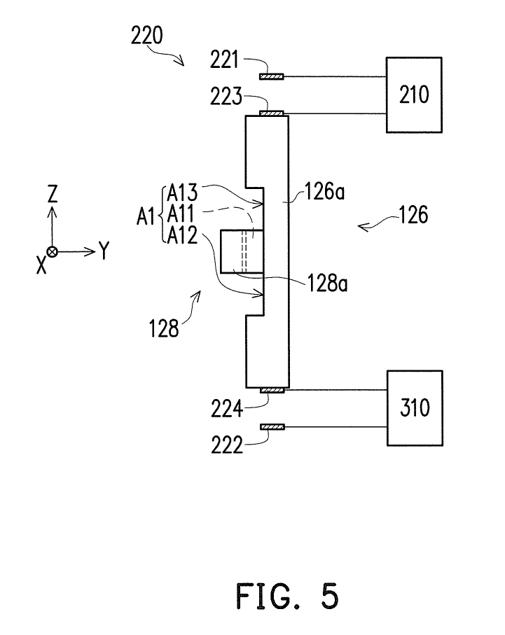

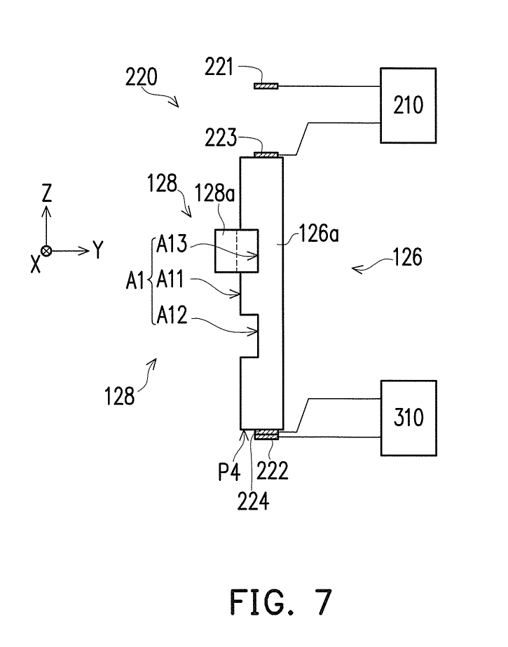

FIG. 5 to FIG. 7 are schematic diagrams of a switch structure according to another embodiment of the invention, in which corresponding positions of related components are described when the switch structure are in different states, and meanwhile components the same with that of the aforementioned embodiment are omitted. Referring to FIG. 5 and FIG. 7, in the present embodiment, the switch structure 220 is adapted to turn on or turn off a corresponding electronic unit 210 or 310. As shown in FIG. 5, the switch structure 220 includes electrodes 221, 222, 223 and 224, a first electromagnetic valve unit 126 and a second electromagnetic valve unit 128, where the first electromagnetic valve unit 126 and the second electromagnetic valve unit 128 may refer to description of the related components in the aforementioned embodiment, and details thereof are not repeated. A difference between the present embodiment and the aforementioned embodiment is that the electrodes 221 and 222 are disposed at two opposites sides of the first moving member 126a along the Z-axis, and the electrodes 223 and 224 are respectively disposed on two opposite ends of the first moving member 126a, and the electrodes 221 and 223 are used for turning on/off the electronic unit 210, and the electrodes 222 and 224 are used for turning on/off the electronic unit 310. Moreover, the first tenon unit A1 includes a block A11 and grooves A12 and A13 arranged along the Z-axis, where the block A11 is located between the grooves A12 and A13.

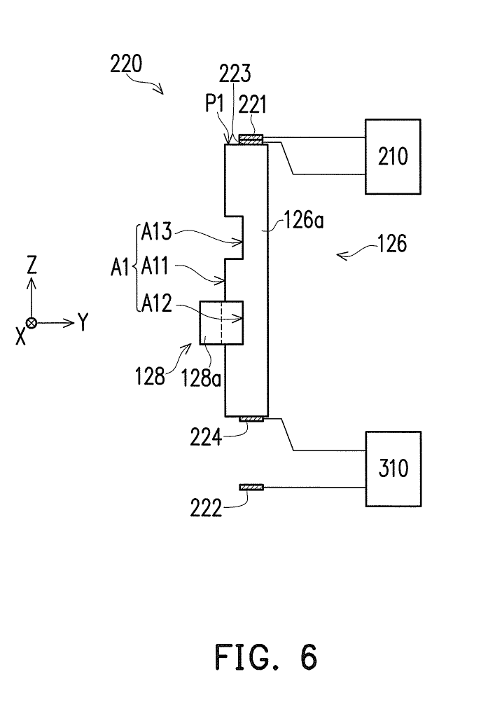

When the first moving member 126a is controlled by the first coil 126b and the first power supply 126c (referring to FIG. 2 to FIG. 4, which is not repeated) to move towards the positive Z-axis direction, the electrodes 221 and 223 can be electrically connected to turn on the electronic unit 210, and meanwhile the electrodes 222 and 224 are away from each other to turn off the electronic unit 310, as shown in FIG. 6 (referring to structure features of the second moving member 128a shown in FIG. 2 to FIG. 4), when the second moving member 128a moves to the position P3, and the first moving member 126a moves to the position P1, and then the second moving member 128a is driven to move to the position P2, and the first moving member 126a and the second moving member 128a are interfered with each other.

Comparatively, when the first moving member 126 is controlled by the first coil 126b and the first power supply 126c (referring to FIG. 2 to FIG. 4, which is not repeated) to move towards the negative Z-axis direction (the second moving member 128a is required to be first driven to the position P3, and the first moving member 126a is moved from the position P1 to the position P4, and then the second moving member 128a is driven to move to the position P3, such that the first moving member 126a and the second moving member 128a are interfered with each other), the electrodes 222 and 224 can be electrically connected to turn on the electronic unit 310, and meanwhile the electrodes 221 and 223 are away from each other to turn off the electronic unit 210, as shown in FIG. 7.

In an embodiment that is not illustrated, moving components capable of moving oppositely relative to each other can be configured between the electronic units 210 and 310 to replace the first moving members 126a. In other words, the moving components can be controlled by a magnetic force to move towards the positive Z-axis direction and the negative Z-axis direction through related mechanism parts (for example, a screw having reverse threads, gears, etc.), such that the moving components can simultaneously turn on/off the electronic units 210 and 310 in a two-way moving mode. Similarly, by using the aforementioned first tenon unit A1 and the second tenon unit A2, the second moving member 128a can be interfered with the moving components, such that the moving components can maintain an electrical connection state or a disconnection state between the electrodes 221 to 224 due to the interference in case that the moving components are not driven by the magnetic force.

In summary, in the switch structure of the power line device, based on the moving members having orthogonal configuration and orthogonal movement, while the first moving member is moved to connect or disconnect the electrodes, the second moving member can be interfered with the first moving member, such that the first electromagnetic valve unit can be still maintained to a position suitable for turning on the communication unit due to the structural interference in case that the first electromagnetic valve unit is not supplied with power, and the communication unit is maintained to a turn-on state to avoid a risk of being turned off due to power-off. In other words, the power line device of the invention can achieve the required communication function without being kept in a power-on state, such that the power line device may have a better power saving effect by using the aforementioned switch structure.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A switch structure, comprising:
a first electrode;
a first moving member, movably disposed next to the first electrode along a first axis, and having a first tenon unit;
a second electrode, disposed at one end of the first moving member and facing the first electrode; and
a second moving member, movably disposed next to the first moving member along a second axis, and having a second tenon unit, wherein the first axis is orthogonal to the second axis, and when the first moving member moves to a first position and the second moving member moves to a second position, the first tenon unit and the second tenon unit are interfered with each other, and the first electrode is electrically connected to the second electrode, and when the second moving member moves to a third position, the first moving member moves along the first axis and passes by the second moving member.

2. The switch structure as claimed in claim 1, further comprising:
a first electromagnetic valve unit, having the first moving member, a first coil and a first power supply, wherein the first moving member is sleeved by the first coil, and the first power supply is electrically connected to the first coil; and
a second electromagnetic valve unit, having the second moving member, a second coil and a second power supply, wherein the second moving member is sleeved by the second coil, and the second power supply is electrically connected to the second coil.

3. The switch structure as claimed in claim 1, wherein the first tenon unit comprises a first block and a first groove arranged along the first axis, the second tenon unit comprises a second block and a second groove arranged along the second axis, when the first moving member moves to the first position, and the second moving member moves to the second position, the second block moves to the first groove to interfere with the first block, such that the second moving member stops the first moving member to move along the first axis, and when the second moving member moves to the third position, the first moving member moves along the first axis and passes by the second groove.

4. The switch structure as claimed in claim 1, further comprising:
a substrate, located at one side of the first moving member along the first axis; and
an elastic member, connected between the substrate and another end of the first moving member relative to the second electrode, and keeping driving the first moving member to depart from the first position.

5. The switch structure as claimed in claim 1, further comprising:
a substrate, located at one side of the first moving member along the first axis; and
an elastic member, connected between the substrate and another end of the first moving member relative to the second electrode, and keeping driving the first moving member to move to the first position.

6. The switch structure as claimed in claim 1, further comprising:
a third electrode, disposed relative to the first electrode along the first axis;
a fourth electrode, disposed on the first moving member at another end relative to the second electrode, wherein the fourth electrode faces the third electrode, when the first moving member moves to the first position, and the second moving member moves to the second position, the third electrode is away from the fourth electrode, and when the first moving member moves to a fourth position, the third electrode is electrically connected to the fourth electrode, and the first electrode is away from the second electrode.

7. The switch structure as claimed in claim 6, wherein the first tenon unit comprises a first block, a first groove and a third groove arranged along the first axis, the second tenon unit comprises a second block and a second groove arranged along the second axis, when the first moving member moves to the first position, and the second moving member moves to the second position, the second block moves to the first groove to interfere with the first block, or when the first moving member moves to a fourth position, and the second moving member moves to the second position, the second block moves to the third groove to interfere with the first block, such that the second moving member stops the first moving member to move along the first axis.

8. The switch structure as claimed in claim 7, wherein the first block is located between the first groove and the third groove.
